(19) United States
(12) Patent Application Publication
(10) Pub. No.: US 2021/0195241 A1
(43) Pub. Date: Jun. 24, 2021

(54) METHOD AND DEVICE FOR PERFORMING TRANSFORM USING ROW-COLUMN TRANSFORMS

(71) Applicant: LG Electronics Inc., Seoul (KR)

(72) Inventors: Hilmi E. EGILMEZ, San Jose, CA (US); Onur G. GULERYUZ, San Jose, CA (US); Jana EHMANN, San Jose, CA (US); Sehoon YEA, Seoul (KR)

(21) Appl. No.: 16/074,364

(22) PCT Filed: Feb. 1, 2017
(86) PCT No.: PCT/KR2017/001053

§ 371 Date: Jul. 31, 2018

Related U.S. Application Data
(60) Provisional application No. 62/289,888, filed on Feb. 1, 2016.

(51) Int. Cl. H04N 19/60; H04N 19/124; H04N 19/88; H04N 19/18; G06F 7/78

(52) U.S. Cl. CPC H04N 19/60; H04N 19/124; G06F 7/78; H04N 19/18; H04N 19/88

(57) ABSTRACT

The present invention provides a method for performing a transform, the method comprising the steps of: deriving a row transform set, a column transform set, and a permutation matrix on the basis of a given transform matrix (H) and error tolerance parameter; obtaining a row-column transform (RCT) coefficient on the basis of the row transform set, the column transform set, and the permutation matrix; and performing a quantization and an entropy encoding on the RCT coefficient, wherein the permutation matrix represents a matrix obtained by permutating a row of an identity matrix.

### CROSS-REFERENCE TO RELATED APPLICATIONS

This application is the National Stage filing under 35 U.S.C. 371 of International Application No. PCT/KR2017/001053, filed on Feb. 1, 2017, which claims the benefit of U.S. Provisional Applications No. 62/289,888, filed on Feb. 1, 2016, the contents of which are all hereby incorporated by reference herein in their entirety.

### TECHNICAL FIELD

The present invention relates to a method and apparatus for encoding/decoding a video signal and, more particularly, to a technology of approximating a non-separable transform using a Row-Column Transform (RCT).

### BACKGROUND ART

Compression encoding means a series of signal processing technologies for transmitting digitized information through a communication line or storing the information in a form suitable for a storage medium. Media, such as a picture, an image and voice, may be the subject of compression encoding. In particular, a technology performing compression encoding on an image is called video image compression.

Next-generation video content will have features of high spatial resolution, a high frame rate, and high dimensionality of scene representation. Processing such content will result in a tremendous increase in terms of memory storage, a memory access rate, and processing power.

Therefore, there is a need to design a coding tool for processing next-generation video content more efficiently.

In particular, many image processing and compressing schemes have adapted separable transforms. For example, a Discrete Cosine Transform (DCT) provides good approximation to a Karhunen-Loeve transform (KLT) in response to a high inter pixel correlation, and it is used widely due to low complexity. Regardless of use of separable transforms, natural image compression has very different statistical properties, so better compression may be performed only by means of a complex transform applicable to variable statistical properties of signal blocks.

Actual implementations have been so far focused on separable approximation of such transforms in order to provide a low-complex reasonable coding gain. For example, a mode-dependent transform scheme is designed such that a separable KLT reduces complexity of a non-separable KLT for each mode. In another example, a Asymmetric Discrete Sine Transform (ADST) is integrated into a hybrid DCT/ADST scheme and designing a separable sparse orthonormal transform and the like has been considered.

### DISCLOSURE

### Technical Problem

The present invention is to provide a method of enhancing coding efficiency with a new transform design.

The present invention is to design a transform which provides a low-complexity reasonable coding gain.

The present invention is to design a Row-Column Transform (RCT) which approximates a high-complexity transform.

The present invention is to provide a method of approximating a non-separable transform with a RCT.

The present invention is to provide a structure of an encoder/decoder to reflect a new transform design.

### Technical Solution

The present invention provides a method of enhancing coding efficiency with a new transform design.

The present invention provides a method of a non-separable transform with a Row-Column Transform (RCT).

The present invention provides a method of designing a two-dimensional (2D) non-separable transform based on one-dimensional (1D) linear transforms and a permutation matrix.

The present invention provides a method of obtaining a Row-Column Transform (RCT) on the basis of a row transform set, a column transform set, and a permutation matrix.

### Advantageous Effects

The present invention may improve coding efficiency with a new transform design. By providing a Row-Column Transform which is a two-dimensional non-separable transform defined based on a set of one-dimensional linear transforms and a basis order permutation, it is possible to approximate a given complex target transform with the same complexity level as that of separable transforms but with much increased fidelity.

The present invention optimizes linear transforms related to a RCT as well as a basis order permutation, and thus, the RCT exhibits performance more similar to that of complex transforms, compared to approximation of a separable transform. Since a reordering permutation is integrated, a separable transform done by a proposed algorithm exhibits better performance than approximation of a pure separable transform.

Therefore, a RCT of the present invention actually outdoes approximation of a well-designed separable transform. All basis functions of a transform do not have the same significance in compression and other applications. In particular, when it is relatively hard to approximate transforms, it is possible to further improve application performance of the RCTs using weight functions.

### BRIEF DESCRIPTION OF THE DRAWINGS

FIG. 1 shows a schematic block diagram of an encoder for encoding a video signal according to one embodiment of the present invention.

FIG. 2 shows a schematic block diagram of a decoder for decoding a video signal according to one embodiment of the present invention.

FIG. 3 is a diagram for illustrating a split structure of a coding unit according to one embodiment of the present invention.

FIG. 4 is a schematic block diagram of a transform unit to which an Row-Column Transform (RCT) and a permutation matrix are applied according to one embodiment of the present invention.

FIG. 5 is a diagram illustrating a process of applying a RCT and a permutation matrix according to one embodiment of the present invention.

FIG. 6 is a flowchart illustrating a process of obtaining a RCT coefficient according to one embodiment of the present invention.

FIG. 7 is a flowchart illustrating a process of performing a decoding on a RCT coefficient according to one embodiment of the present invention.

FIG. 8 is a flowchart illustrating a process of performing an inverse-permutation on a RCT coefficient according to one embodiment of the present invention.

FIG. 9 is a graph showing approximation results of eight Sparse Orthonormal Transforms (SOTs) using a RCT and a separable approximation according to one embodiment of the present invention.

FIGS. 10 to 12 are diagrams illustrating a distortion rate and a gain rate for images according to embodiments of the present invention.

FIG. 13 illustrates separable approximations to RC and (90°-oriented) SOT5 in the case of high RC approximation performance according to one embodiment of the present invention.

FIG. 14 illustrates separable approximations to RC and (135°-oriented) SOT7 in the case of low RC approximation performance according to one embodiment of the present invention.

### BEST MODE

The present invention provides a method for performing a transform using a Row-Column Transform (RCT), including deriving a row transform set, a column transform set and a permutation matrix based on a given transform matrix(H) and an error tolerance parameter; obtaining a RCT coefficient based on the row transform set, the column transform set, and the permutation matrix; and performing a quantization and an entropy-encoding on the RCT coefficient, wherein the permutation matrix is obtained by permuting a row of an identify matrix.

The permutation matrix may be derived from an optimization process, and the optimization process is determined based on a matching between a RCT matrix and the given transform matrix, and the RCT matrix may be derived using the row transform set and the column transform set.

Each transform in the row transform set and the column transform set may be orthonormal.

Each of the row transform set and the column transform set may have a single transform.

The row transform set may have a single transform, the column transform set may have another single transform.

The row transform set and the column transform may be used for at least one of a square region, a rectangular region, or an arbitrary region.

The RCT coefficient may be obtained by performing a row transform and then a column transform.

In addition, the present invention provides a method of performing an inverse-transform using a Row-Column Transform (RCT), the method including: receiving a video signal; obtaining a coefficient from the video signal through entropy decoding and inverse-quantization; performing an inverse-permutation on the coefficient; performing an inverse-transform on the inverse-permutated coefficient; and reconstructing the video signal using the inverse-permutated coefficient.

The performing of an inverse-permutation may include: performing an inverse-column transform on the inverse-permutated coefficient; and performing an inverse-row transform on the row-column transformed coefficient.

In addition, the present invention provides an apparatus for performing a transform using a Row-Column Transform (RCT), the apparatus including: a transform unit configured to derive a row transform set, a column transform set, and a permutation matrix based on a given transform matrix H and an error tolerance parameter, and obtain a RCT coefficient based on the row transform set, the column transform set, and the permutation matrix; a quantization unit configured to perform a quantization on the RCT coefficient; and an entropy encoding unit configured to perform an entropy encoding on the quantized RCT coefficient, wherein the permutation matrix represents a matrix obtained by substituting a row of an identity matrix.

In addition, the present invention provides an apparatus for performing an inverse-transform using a Row-Column Transform (RCT), the apparatus including: a receiver configured to receive a video signal comprising a residual signal; an entropy decoding unit configured to perform an entropy decoding on the residual signal; an inverse-transform unit configured to perform an inverse-permutation on the coefficient and perform an inverse-transform on the inverse-permutated coefficient; and a reconstruction unit configured to reconstruct the video signal using the inverse-transformed coefficient.

### MODE FOR THE INVENTION

Hereinafter, exemplary elements and operations in accordance with embodiments of the present invention are described with reference to the accompanying drawings, however, it is to be noted that the elements and operations of the present invention described with reference to the drawings are provided as only embodiments and the technical ideas and core elements and operation of the present invention are not limited thereto.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly substituted and interpreted in each coding process. Further, partitioning, decomposition, splitting, and split, etc. may also be appropriately substituted and interpreted with each other for each coding process.

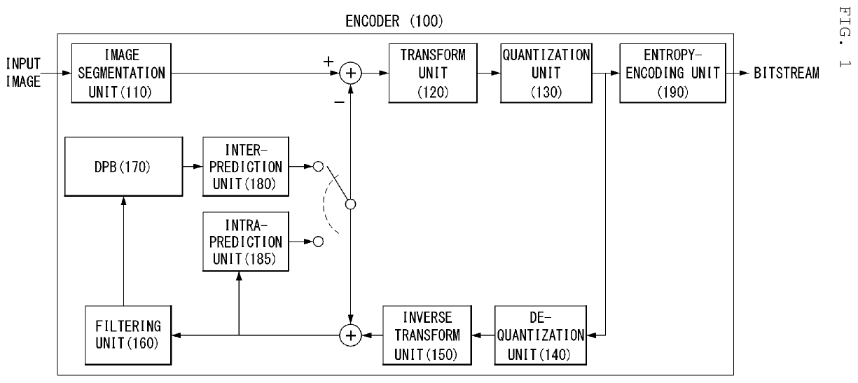

FIG. 1 shows a schematic block diagram of an encoder for encoding a video signal, according to one embodiment of the present invention.

Referring to FIG. 1, the encoder 100 may include an image segmentation unit 110, a transform unit 120, a quantization unit 130, a de-quantization unit 140, an inverse transform unit 150, a filtering unit 160, a decoded picture buffer (DPB) 170, an inter prediction unit 180, an intra prediction unit 185, and an entropy encoding unit 190.

The image segmentation unit 110 may divide an input image (or a picture or a frame) input to the encoder 100 into one or more process units. For example, the process unit may be a coding tree unit (CTU), a coding unit (CU), a prediction unit (PU) or a transform unit (TU).

However, the terms are used only for convenience of illustration of the present invention. The present invention is not limited to the definitions of the terms. In this specification, for convenience of illustration, the term “coding unit” is used as a unit used in a process of encoding or decoding a video signal, but the present invention is not limited thereto. Another process unit may be appropriately selected based on the contents of the present invention.

The encoder 100 may generate a residual signal by subtracting a prediction signal output by the inter prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square or to a block of a variable size other than a square.

The quantization unit 130 may quantize the transform coefficient and transmits the quantized coefficient to the entropy encoding unit 190. The entropy encoding unit 190 may entropy-code the quantized signal and then output the entropy-coded signal as bit streams.

The quantized signal output by the quantization unit 130 may be used to generate a prediction signal. For example, the quantized signal may be subjected to a de-quantization and an inverse transform via the de-quantization unit 140 and the inverse transform unit 150 in the loop respectively to reconstruct a residual signal. The reconstructed residual signal may be added to the prediction signal output by the inter prediction unit 180 or intra prediction unit 185 to generate a reconstructed signal.

Meanwhile, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter prediction unit 180.

The inter prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter prediction unit 180 may interpolate signals between pixels on a subpixel basis using a low-pass filter. In this case, the subpixel may mean a virtual pixel generated by applying an interpolation filter. An integer pixel means an actual pixel within the reconstructed picture. The interpolation method may include linear interpolation, bi-linear interpolation and Wiener filter, etc.

The interpolation filter may be applied to the reconstructed picture to improve the accuracy of the prediction. For example, the inter prediction unit 180 may apply the interpolation filter to integer pixels to generate interpolated pixels. The inter prediction unit 180 may perform prediction using an interpolated block composed of the interpolated pixels as a prediction block.

Meanwhile, the intra prediction unit 185 may predict a current block by referring to samples in the vicinity of a block to be encoded currently. The intra prediction unit 185 may perform a following procedure to perform intra-prediction. First, the intra prediction unit 185 may prepare reference samples needed to generate a prediction signal. Thereafter, the intra prediction unit 185 may generate the prediction signal using the prepared reference samples. Thereafter, the intra prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction

The prediction signal generated via the inter prediction unit 180 or the intra prediction unit 185 may be used to generate the reconstructed signal or used to generate the residual signal.

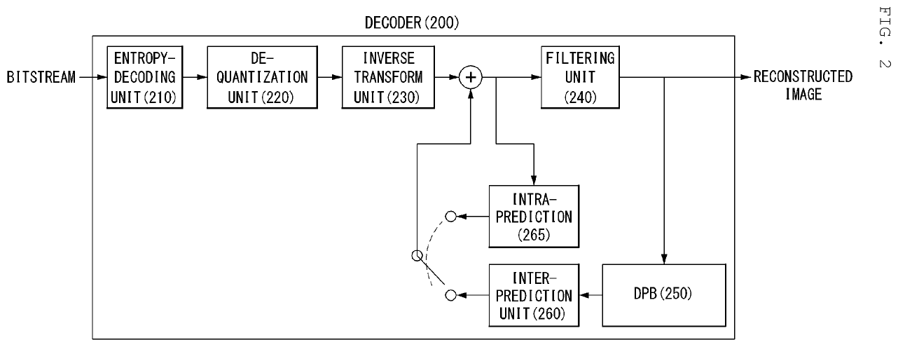

FIG. 2 shows a schematic block diagram of a decoder for decoding a video signal according to one embodiment of the present invention.

Referring to FIG. 2, the decoder 200 may include a parsing unit (not shown), an entropy decoding unit 210, a de-quantization unit 220, an inverse transform unit 230, a filtering unit 240, a decoded picture buffer (DPB) 250, an inter prediction unit 260 and an intra prediction unit 265.

A reconstructed video signal output by the decoder 200 may be reproduced using a playback device.

The decoder 200 may receive the signal output by the encoder as shown in FIG. 1. The received signal may be entropy-decoded via the entropy decoding unit 210.

The de-quantization unit 220 obtains a transform coefficient from an entropy-decoded signal using quantization step size information.

The inverse transform unit 230 obtains a residual signal by performing an inverse-transform for the transform coefficient.

A reconstructed signal may be generated by adding the obtained residual signal to the prediction signal output by the inter prediction unit 260 or the intra prediction unit 265.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter prediction unit 260.

In this specification, the same embodiments described regarding the transform unit 120 and each function unit of the encoder 100 may be applied to the inverse transform unit 230 and any corresponding function unit of the decoder.

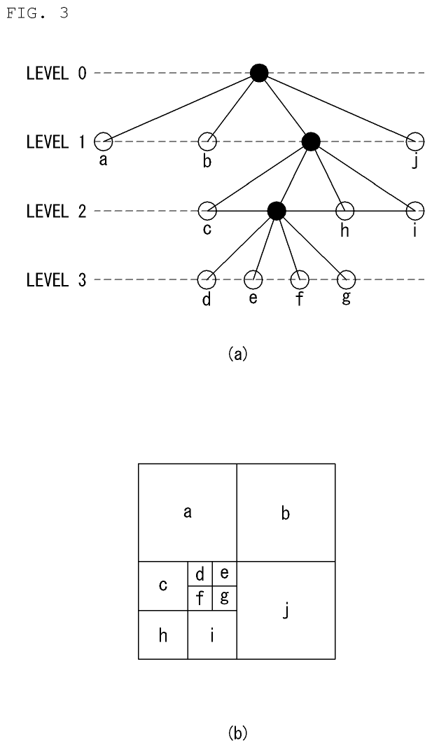

FIG. 3 is a diagram for illustrating a split structure of a coding unit, according to one embodiment of the present invention.

The encoder may split or divide one image or picture into a rectangular coding tree unit (CTU). Thereafter, the encoder may sequentially encode CTUs one by one according to the raster scan order.

For example, the size of a CTU may be set to 64×64, 32×32 or 16×16, but the present invention is not limited thereto. The encoder may select the size of a CTU based on resolution of an input image or the characteristics of an input image. A CTU may include a coding tree block (CTB) for a luma component and a coding tree block (CTB) for corresponding two chroma components.

A single CTU may be decomposed into a quad-tree (hereinafter referred to as a “QT”) structure. For example, one CTU may be divided into four units, each unit having a square shape, with a length of each side thereof decreasing by one half. This decomposition or division of the QT structure may be performed recursively.

Referring to FIG. 3, a root node of the QT may be related to the CTU. The QT may be partitioned until a leaf node is reached. In this case, the leaf node may be referred to as a coding unit (CU).

The CU may refer to a base unit for the coding process of an input image, for example, a base unit for intra/inter-predictions. The CU may include a CB for a luma component and a CB for two chroma components corresponding to the luma component. For example, the size of the CU may be set to 64×64, 32×32, 16×16 or 8×8. However, the present invention is not limited thereto. In the case of a high-resolution image, the size of the CU may be increased or varied.

Referring to FIG. 3, the CTU may correspond to the root node, and may have the smallest depth (i.e., level 0). Depending on the characteristics of the input image, the CTU may not be divided. In this case, the CTU corresponds to the CU.

The CTU may be decomposed into a QT form. As a result, sub-nodes, each having a depth of level 1, may be generated. Among the sub-nodes, each having a depth of level 1, a sub-node (i.e., a leaf node) that is not further divided corresponds to a CU. For example, in FIG. 3(b), each of the coding units CU(a), CU(b), and CU(j) corresponding to nodes a, b and j, respectively, is split in a CTU once, thus having a depth of level 1.

At least one of sub-nodes; each one having a depth of level 1 may be further split into a QT form. Among the sub-nodes, each having a depth of level 2, a sub-node (i.e., a leaf node) that is not further divided corresponds to a CU. For example, in FIG. 3(b), each of the coding units CU(c), CU(h), and CU(i) corresponding to nodes c, h and i respectively are partitioned two times in the CTU and thus has a depth of level 2.

Further, among the sub-nodes, each having a depth of level 2, at least one sub-node may be further split into a QT form. Among the sub-nodes, each having a depth of level 3, a sub-node (i.e., a leaf node) that is not further divided corresponds to a CU. For example, in FIG. 3(b), each of the coding units CU(d), CU(e), CU(f) and CU(g) corresponding to nodes d, e, f and g respectively are partitioned three times in the CTU and thus has a depth of level 3.

The encoder may determine a maximum or minimum size of the CU based on the characteristics (e.g., resolution) of the video image or the efficiency of coding. Information on the maximum or minimum size and/or information used for deriving the maximum or minimum size may be included in the bit stream. Hereinafter, a CU having a maximum size may be referred to as a LCU (Largest Coding Unit), while a CU having a minimum size may be referred to as a SCU (Smallest Coding Unit).

In addition, a CU having a tree structure may have a predetermined maximum depth information (or maximum level information) and may be hierarchically divided. Further, each divided CU may have depth information. The depth information indicates the number and/or degree of divisions of the CU. Thus, the depth information may include information about the size of the CU.

The LCU is divided into a QT form. Therefore, the size of the SCU may be obtained using the LCU size and the maximum depth information of the tree. Conversely, the size of the SCU and the maximum depth information of the tree may be used to determine the size of the LCU.

For a single CU, information indicating whether or not the CU is divided may be transmitted to the decoder. For example, the information may be defined as a split flag and may be represented by a syntax element “split_cu_flag.” The split flag may be included in all CUs except a SCU. For example, when the value of the split flag is “1”, the corresponding CU is further divided into four CUs. When the value of the split flag is “0”, the corresponding CU is not further divided, and, then, the coding process for the corresponding CU may be performed.

In the embodiment shown in FIG. 3, although the QT structure described above is applied to the CU division by way of example, the QT structure described above may be equally applied to TU (transform unit) division, where the TU is a base unit for performing transform.

The TU may be hierarchically partitioned from the CU to be coded into a QT structure. For example, the CU may correspond to a root node of the tree for the transform unit TU.

The TU is divided into a QT structure. Thus, each of TUs divided from the CU may be further divided into smaller sub-TUs. For example, the size of the TU may be set to 32×32, 16×16, 8×8 or 4×4. However, the present invention is not limited thereto. For high-resolution images, the size of a TU may be larger or may vary.

For a single TU, information indicating whether or not the TU is divided may be transmitted to the decoder. For example, the information may be defined as a split transform flag and may be represented by a syntax element “split_transform_flag”.

The split transform flag may be included in all TUs except the smallest TU (STU). For example, when the value of the split transform flag is “1”, the corresponding TU is further divided into four TUs. When the value of the split transform flag is “0”, the corresponding TU is not further divided, and, then, the coding process for the corresponding TU may be performed.

As described above, a CU is a base unit for the coding process in which the intra-prediction or inter-prediction is performed. In order to more effectively code the input image, the CU may be divided into PUs (Prediction Units).

A PU is a base unit forming a prediction block. It is possible to generate different prediction blocks on a PU basis even within a single CU. The PU may be divided differently depending on whether an intra-prediction mode or an inter-prediction mode is used as a coding mode for a CU to which the PU belongs.

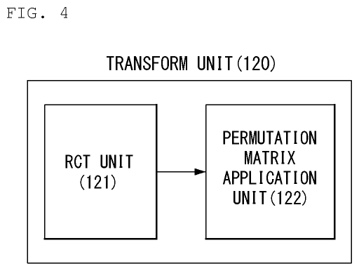

FIG. 4 is a schematic block diagram of a transform unit to which an Row-Column Transform (RCT) and a permutation matrix are applied according to one embodiment of the present invention.

The present invention provides a RCT which is two-dimensional separable transforms defined based on one-dimensional linear transform sets and a basis ordering permutation.

When block transforms non-separable for a region of interest in an image are given, the present invention may design a RCT by optimizing one-dimensional linear transform sets to be applied to rows and columns of blocks and obtaining an ordering permutation of an optimal transform coefficient. RCTs optimized in the above manner may have compression performance very close to that of non-separable transforms while maintaining a computation complexity level of separable transforms.

The transform unit 120 to which the present invention is applied may largely include a RCT unit 121 and a permutation matrix application unit 122

The RCT unit 121 may derive a row transform set, a column transform set, and a permutation matrix on the basis of a given transform matrix H and an error tolerance parameter. The permutation matrix may be derived from an optimization process. The optimization process may be determined based on a matching between a RCT matrix and the given transform matrix H. The RCT matrix may be derived using the row transform set and the column transform set. For example, the RCT matrix may represent a matrix G in Equation 2 and Equation 3 which will be described later on.

The RCT unit 121 may obtain a transform coefficient based on the row transform set and the column transform set. For example, the transform coefficient may be acquired by performing the row transform and then the column transform.

The permutation matrix application unit 122 may obtain a RCT coefficient by applying the matrix to the transform coefficient.

In this embodiment, operation of the transform unit 120 has been described on the basis of the permutation matrix application unit 122, but the present invention is not limited thereto, and it may be understood that the process of obtaining a RCT coefficient is performed in the transform unit 120.

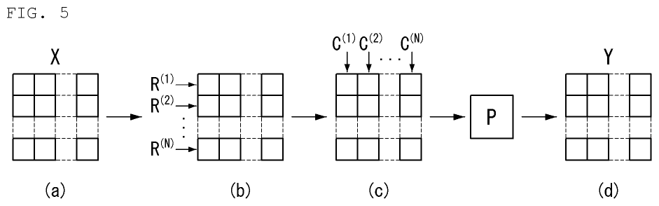

FIG. 5 is a diagram illustrating a process of applying a RCT and a permutation matrix according to one embodiment of the present invention.

Referring to FIGS. 5(a) to 5(d), a series of processes are found in which a row transform and then a column transform is performed on a block X and a permutation matrix P is applied to thereby obtain a transform coefficient Y.

As a new method for approximating a non-separable transform, the present invention employs a RCT. The RCT may be defined as a set of one-dimensional transforms which is followed by a permutation of coefficients, and which are applied to rows and columns of signal blocks.

Designing or determining a RCT for N×N blocks is dependent on join optimization between (2N+1) number of matrixes (that is, (N×N) transform matrixes R⁽ⁱ⁾, C⁽ⁱ⁾, i=1, . . . , N and a (N²×N²) permutation matrix P).

A RCT proposed in the present invention has an advantage of providing better approximations of non-separable transforms while maintaining complexity levels of separable transforms. In particular, in order to transform (N×N) blocks, the RCT needs multiply-adds of 2N³ (or 2N² log N when a fast transform is used), but an average non-separable transform has a computation complexity level of N⁴.

Hereinafter, a method of designing a RCT will be described in more detail.

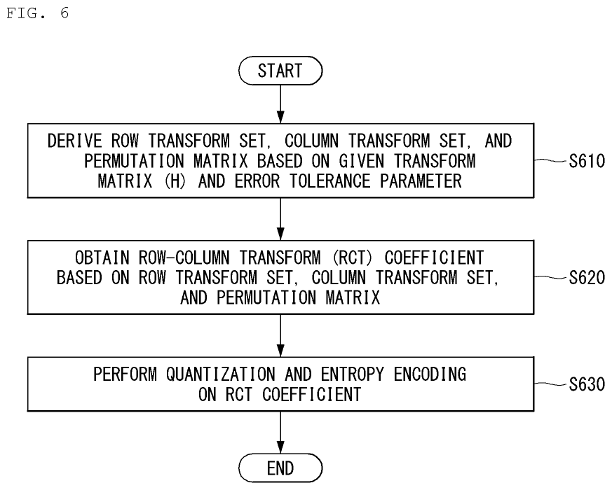

FIG. 6 is a flowchart illustrating a process of obtaining a RCT coefficient according to one embodiment of the present invention.

An encoder to which the present invention is applied may derive a row transform set, a column transform set, and a permutation matrix on the basis of a given transform matrix H and an error tolerance parameter (S610). The permutation matrix may represent a matrix which is obtained by substituting a row of an identity matrix.

According to one embodiment of the present invention, the permutation matrix may be derived from an optimization process. The optimization process may be determined through a matching between a RCT matrix and the given transform matrix H. The RCT matrix may be derived using the row matrix set and the column transform set. For example, the RCT matrix may represent Equation 2 and Equation 3 which will be described later on.

A more detailed process will be described in the following.

According to one embodiment of the present invention, each transform in the row transform set and the column transform set may be orthonormal. That is, each transform forming the row transform set and the column transform set may be orthonormal. However, the present invention is not limited thereto, and a RCT derived by an algorithm proposed in the present invention may not be orthogonal.

According to one embodiment of the present invention, each of the row transform set and the column transform set may have a single transform.

According to another embodiment of the present invention, the row transform set may have a single transform and the column transform set may have another single transform.

According to one embodiment of the present invention, the row transform set and the column transform set may be used for at least one of a square region, a rectangular region, or an arbitrary region.

The encoder may obtain a RCT coefficient on the basis of the row transform set, the column transform set, and the permutation matrix (S620). The RCT coefficient may be obtained by performing a row transform and then a column transform.

The encoder may perform a quantization on the RCT coefficient, and perform an entropy encoding on the quantized RCT coefficient (S630).

Definition of RCT (Row-Column Transform)

When it comes to a transform of a N×N block X, suppose that x=vec (X) is a vector obtained by row-major ordering of the block X. Then, suppose that two sets of one-dimensional transforms are expressed as R={R⁽ⁱ⁾, . . . , R^{(N)}} and C={C⁽ⁱ⁾, . . . , C^{(N)}}. In this case, R⁽ⁱ⁾ and C⁽ⁱ⁾ (i=1, . . . , N) represents a (N×N) matrix.

R⁽ⁱ⁾=[r₁⁽ⁱ⁾ r₂⁽ⁱ⁾ . . . r_{N}⁽ⁱ⁾] and C^{(j)}=[c₁^{(j)} c₂^{(j)} . . . c_{N}^{(j)}] are used to transform the i-th row and the j-th column of each block. In this case, rₖ⁽ⁱ⁾ . . . (N×1) is the k-th basis function of the i-th row transform, and cᵢ^{(j)} (N×1) is the l-th basis function of the j-th column. This may be represented by a matrix as in the following Equation 1.

$${B}_{i}^{T} = [ \begin{matrix}{r}_{i}^{( 1 ) T} & 0 & … & 0 \\ 0 & {r}_{i}^{( 2 ) T} & ⋱ & ⋮ \\ ⋮ & ⋱ & ⋱ & 0 \\ 0 & … & 0 & {r}_{i}^{( N ) T}\end{matrix} ] \qquad [ Equation 1 ]$$

Using Equation 1, a RCT matrix G(N²×N²) may be defined as in Equation 2.

$${G}^{T} = [ \begin{matrix}{C}^{( 1 ) T} & 0 & … & 0 \\ 0 & {C}^{( 2 ) T} & ⋱ & ⋮ \\ ⋮ & ⋱ & ⋱ & 0 \\ 0 & … & 0 & {C}^{( N ) T}\end{matrix} ] [ \begin{matrix}{B}_{1}^{T} \\ {B}_{2}^{T} \\ ⋮ \\ {B}_{N}^{T}\end{matrix} ] \qquad [ Equation 2 ]$$

This may be expressed as Equation 3.

G=[B₁C⁽¹⁾B₂C⁽²⁾ . . . B_{N}C^{(N)}] [Equation 3]

Thus, a transform of the block X affects G^{T}_{X}.

Design of RCT (Row-Column Transform)

Optimal row-column (RC) approximation of a desired transform matrix H∈ [symbol] ^{(N}^{²}^{×N}^{²}⁾ may be expressed as an optimization problem of Equation 4.

$${minimize}_{G , P} {‖ HP - G ‖}_{F}^{2}$$

$$subject to G := row \text{-} column transform$$

$$P := permutation matrix$$

In this case, ∥·∥_{δ′} represents a Frobenius norm, G represents a RCT matrix, and P represents a permutation matrix. Equation 4 is a joint optimization problem derived from a permutation matrix constraint of P. An row-column (RC) constraint for G may be explicitly expressed as below. If \tilde{C}⁽ⁱ⁾=C^{(i)T}=[\tilde{c}₁⁽ⁱ⁾ \tilde{c}₂⁽ⁱ⁾ . . . \tilde{c}_{N}⁽ⁱ⁾], cⱼ⁽ⁱ⁾ represents the j-th column of \tilde{C}⁽ⁱ⁾. In this case, BᵢC⁽ⁱ⁾ is the same as Equation 5.

$${B}_{i} {C}^{( i )} = [ \begin{matrix}{r}_{i}^{( 1 )} & 0 & … & 0 \\ 0 & {r}_{i}^{( 2 )} & ⋱ & ⋮ \\ ⋮ & ⋱ & ⋱ & 0 \\ 0 & … & 0 & {r}_{i}^{( N )}\end{matrix} ] [ \begin{matrix}{\tilde{c}}_{1}^{( i ) T} \\ {\tilde{c}}_{2}^{( i ) T} \\ ⋮ \\ {\tilde{c}}_{N}^{( i ) T}\end{matrix} ] = [ \begin{matrix}{r}_{i}^{( 1 )} {\tilde{c}}_{1}^{( i ) T} \\ {r}_{i}^{( 2 )} {\tilde{c}}_{2}^{( i ) T} \\ ⋮ \\ {r}_{i}^{( N )} {\tilde{c}}_{N}^{( i ) T}\end{matrix} ] \qquad [ Equation 5 ]$$

If BᵢC⁽ⁱ⁾ in Equation 4 is substituted by Equation 5, Equation 6 may be derived.

$$G = [ \begin{matrix}{r}_{1}^{( 1 )} {\tilde{c}}_{1}^{( 1 ) T} & {r}_{2}^{( 1 )} {\tilde{c}}_{1}^{( 2 ) T} & … & {r}_{N}^{( 1 )} {\tilde{c}}_{1}^{( N ) T} \\ {r}_{1}^{( 2 )} {\tilde{c}}_{2}^{( 1 ) T} & {r}_{2}^{( 2 )} {\tilde{c}}_{2}^{( 2 ) T} & … & {r}_{N}^{( 2 )} {\tilde{c}}_{2}^{( N ) T} \\ ⋮ & ⋮ & ⋱ & ⋮ \\ {r}_{1}^{( N )} {\tilde{c}}_{N}^{( 1 ) T} & {r}_{2}^{( N )} {\tilde{c}}_{N}^{( 2 ) T} & … & {r}_{N}^{( N )} {\tilde{c}}_{N}^{( N ) T}\end{matrix} ] \qquad [ Equation 6 ]$$

In this case, G is each N²×N² block, and each N×N component in Equation 6 (that is, rᵢ^{(j)}\tilde{c}ⱼ^{(i)T} for i,j=1, . . . , N) is a rank-1 matrix. If an optimal permutation matrix in Equation 4 is assumed to be P*, Ĥ=HP* and thus, an objective function of Equation 4 may be expressed as Equation 7.

$${‖ \hat{H} - G ‖}_{F}^{2} = {\sum }_{i = 1}^{N} {\sum }_{j = 1}^{N} {‖ {\hat{H}}_{ij} - {r}_{j}^{( i )} {\tilde{c}}_{i}^{( j ) T} ‖}_{F}^{2} \qquad [ Equation 7 ]$$

In this case, Ĥᵢⱼ is the (i, j)-th N×N partition of a matrix Ĥ, and, that is, the matrix Ĥ may be expressed as Equation 8.

$$\hat{H} = [ \begin{matrix}{\hat{H}}_{11} & {\hat{H}}_{12} & … & {\hat{H}}_{1 N} \\ {\hat{H}}_{21} & {\hat{H}}_{22} & … & {\hat{H}}_{2 N} \\ ⋮ & ⋮ & ⋱ & ⋮ \\ {\hat{H}}_{N 1} & {\hat{H}}_{N 1} & … & {\hat{H}}_{NN}\end{matrix} ]$$

Design Algorithm of RCT (Row-Column Transform)

As a solution of the RCT design problem of Equation 4, the present invention proposes an alternating minimization approach which divides an original problem into two sub-problems.

First, the present invention is to provide a method of a RCT which is the most approximate to Ĥ=HP for a given permutation matrix P. This may derive an optimization problem as Equation 9.

$${minimize}_{{( {r}_{j}^{( i )} , {\tilde{c}}_{i}^{( j )} )}_{∀ ( i , j )}} {\sum }_{i = 1}^{N} {\sum }_{j = 1}^{N} {‖ {\hat{H}}_{ij} - {r}_{j}^{( i )} {\tilde{c}}_{i}^{( j ) T} ‖}_{F}^{2} \qquad [ Equation 9 ]$$

In this case, Ĥᵢⱼ is a partition of Ĥ in Equation 8. Equation 9 may be calculated independently with respect to each (i, j) pair. Minimizing each element in a double summation derives the best rank-1 approximation of Ĥᵢⱼ. This may be optimally solved using Singular Value Decomposition (SVD).

rⱼ⁽ⁱ⁾\tilde{c}ᵢ^{(j)T}=σᵢⱼuᵢⱼvᵢⱼ^{T} [Equation 10]

In this case, uᵢⱼ and vᵢⱼ are left and right singular vectors related to the maximum singular value σᵢⱼ of Ĥᵢⱼ.

Second, the present invention is to provide a method of finding out an optimal permutation matrix for a given G, as shown in Equation 11.

$${minimize}_{P} {‖ HP - G ‖}_{F}^{2} \\ subject to P := permutation matrix \qquad [ Equation 11 ]$$

TABLE 1

| | |
|---|---|
| | Require: Transform matrix H and error tolerance parameter ∈ |
| S1 | Initialize k ← 0, G(0) ← I, P(0) ← I and c ← ∞ |
| | while c > ∈ do |

k ← k + 1 and Ĥ ← HP(k − 1)
for i = 1, ...N do

for j = 1, ...N do

| | |
|---|---|
| S2 | (σᵢⱼ, uᵢⱼ, vᵢⱼ) ← apply SVD to Ĥᵢⱼ in (8) |
| S3 | Ĝᵢⱼ ← σᵢⱼuᵢⱼvᵢⱼ^{T}, using (6) and (10) |

end for

| | |
|---|---|
| | end for |
| S4 | P(k) ← solve (13) given Ĝ and H (Hungarian method) |
| | G(k) ← Ĝ |
| | c ← ∥HP(k − 1) − G(k − 1)∥_{F}² − ∥HP(k) − G(k)∥_{F}² |

| | |
|---|---|
| | end while |
| S5 | Return G* ← G(k), P* ← P(k) |

The above Table 1 shows a RCT design algorithm.

The algorithm 1 solves Equations 9 and 11 to find a transform matrix G* and a permutation matrix P* (S5). For example, an encoder may derive a row transform set, a column transform set, and a permutation matrix based on a given transform matrix H and an error tolerance parameter. In this case, the permutation matrix may represent a matrix obtained by substituting a row of a identity matrix.

The encoder may perform an initialization such that k←0, G(0)←I, P(0)←I, and c←∞(S1). If c>c1, k←k+1 and Ĥ←HP(k−1) may be achieved, and (σᵢⱼ, uᵢⱼ, vᵢⱼ) may be obtained with respect to i=1, . . . , N, j=1, . . . , N (S2). In this case, a Singular Value Decomposition (SVD) may be applied to Ĥᵢⱼ in Equation 8.

The encoder may obtain or derive Ĝᵢⱼ←σᵢⱼuᵢⱼvᵢⱼ^{T} using Equations 6 and 10 (S3).

In addition, regarding a given block X, RCT coefficients may be expressed in a vector form as shown in Equation 12.

y=P*G*^{T}x [Equation 12]

In this case, x=vec(X).

The optimization problem of Equation 11 may be expressed as Equation 13.

$${P}^{*} = {argmax}_{P} Tr ( {G}^{T} HP ) \qquad [ Equation 13 ]$$

In this case, Tr(·) represents a trace and P represents a permutation matrix.

Equation 11 may be differently expressed as Equation 14.

$${argmin}_{P} {‖ HP - G ‖}_{F}^{2} = Tr ( {( HP - G )}^{T} ( HP - G ) ) \\ = {argmin}_{P} Tr ( {P}^{T} {H}^{T} HP - 2 {G}^{T} HP + {G}^{T} G ) \\ = {argmin}_{P} Tr ( {H}^{T} {HPP}^{T} ) - Tr ( 2 {G}^{T} HP ) . \qquad [ Equation 14 ]$$

In this case, PP^{T}=I is satisfied, so Tr(H^{T}HPP^{T}) in Equation 14 is a constant, and therefore, it results in Equation 13. That is, Equation 13 is derived from Equation 14.

Equation 13 is an assignment problem, and it is possible to find an optimal permutation matrix P using a Hungarian method in a polynomial time (S4). The optimal permutation matrix P substitutes columns of the desired transform matrix H (that is, basis vectors), and thus, a summation of inner products of basis vectors between a RCT G and Ĥ=HP may be optimized, as shown in Equation 15.

$$Tr ( {G}^{T} \hat{H} ) {\sum }_{i = 1}^{N} {g}_{i}^{T} {\hat{h}}_{i} \qquad [ Equation 15 ]$$

That is, the optimal permutation matrix P determines the best assignment of basis vectors of H and G.

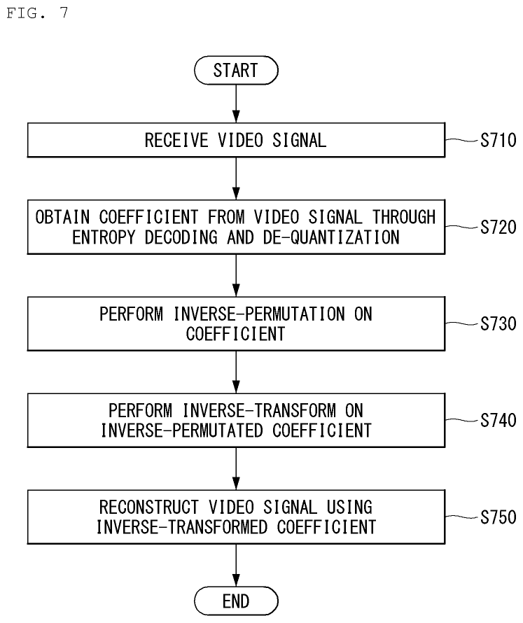

FIG. 7 is a flowchart illustrating a process of performing a decoding on a RCT coefficient according to one embodiment of the present invention.

A decoder to which the present invention is applied may receive a video signal (S710).

The decoder may obtain a coefficient from the video signal through entropy decoding and inverse quantization (S720). The coefficient may be a row-column transform (RCT) coefficient, and the RCT coefficient may be obtained by performing a row transform and then a column transform.

The decoder may perform an inverse-permutation on the coefficient (S730). The inverse-permutation may be performed using an inverse matrix of a permutation matrix, and the permutation matrix may represent a matrix obtained by substituting a row of an identity matrix.

The permutation matrix may be derived from an optimization process. The optimization process may be determined through a matching between a RCT matrix and the given transform matrix H.

The decoder may perform an inverse-transform on the inverse-permutated coefficient (S740).

The decoder may reconstruct the video signal using the inverse-permutated coefficient (S750).

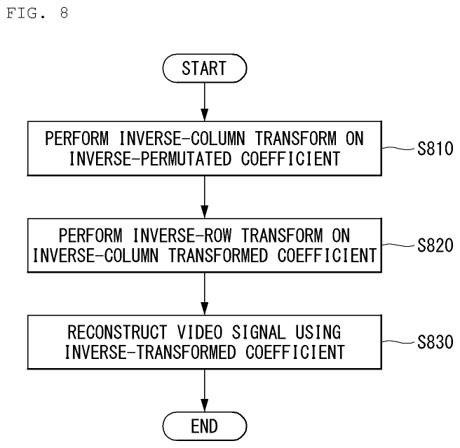

FIG. 8 is a flowchart illustrating a process of performing an inverse-permutation on a RCT coefficient according to one embodiment of the present invention.

A decoder to which the present invention is applied may perform an inverse-column transform on an inverse-permutated coefficient (S810).

Then, the decoder may perform an inverse-row transform on the inverse-column transformed coefficient (S820).

The decoder may reconstruct a video signal using the inverse-transformed coefficient (S830).

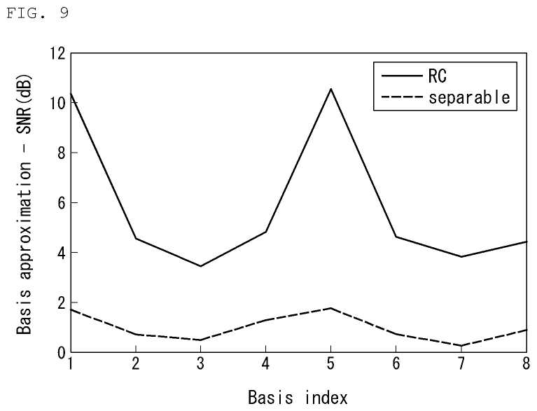

FIG. 9 is a graph showing approximation results of eight Sparse Orthonormal Transforms (SOTs) using a RCT and separable approximations according to one embodiment of the present invention.

Referring to FIG. 9, X-axis represents a basis index, and Y-axis represents (Basis approximation)-SNR(dB).

That is, FIG. 9 shows row-column (RC) and separable approximations of eight non-separable basis SOT1-SOT8. In this case, SOTs are respectively aligned primarily according to 0°, 22.5°, 45°, 67.5°, 90°, 112.5°, 135°, and 157.5°. For each SOT, 20 log₁₀(∥H_{SOT}∥_{F}/∥H_{SOT}−G∥_{F}) is plotted with respect to G=G_{RC} and G=G_{separable}.

According to one embodiment of the present invention, the algorithm shown in Table 1 may be used to approximate a set of SOTs. A SOT basis may be derived from training sets which are used to maximize sparsity of coefficients, for example, with respect to 8×8 blocks, that is, N=8.

The SOT may be generalization of a KLT since it is identical to the KLT when it comes to Gaussian procedures, but the SOT provides considerable improvement over the KLT when it comes to non-Gaussian data. Since trained SOTs tend to have a directional structure with respect to typical images and videos, eight classes may be used to compress image blocks using SOT basis which corresponds to 0°, 22.5°, 45°, 67.5°, 90°, 112.5°, 135°, and 157.5°, respectively.

It is difficult to approximate directional transforms using transforms which are simple in terms of calculation. Since, an SOT is orthonormal, RCTs may be constrained to be orthonormal. Such a constraint is equivalent to a requirement that R⁽ⁱ⁾ and C⁽ⁱ⁾(i=1, . . . , N) be orthonormal. To output separable transforms so as to compare with separable approximations, a corresponding constraint condition may be added to an algorithm.

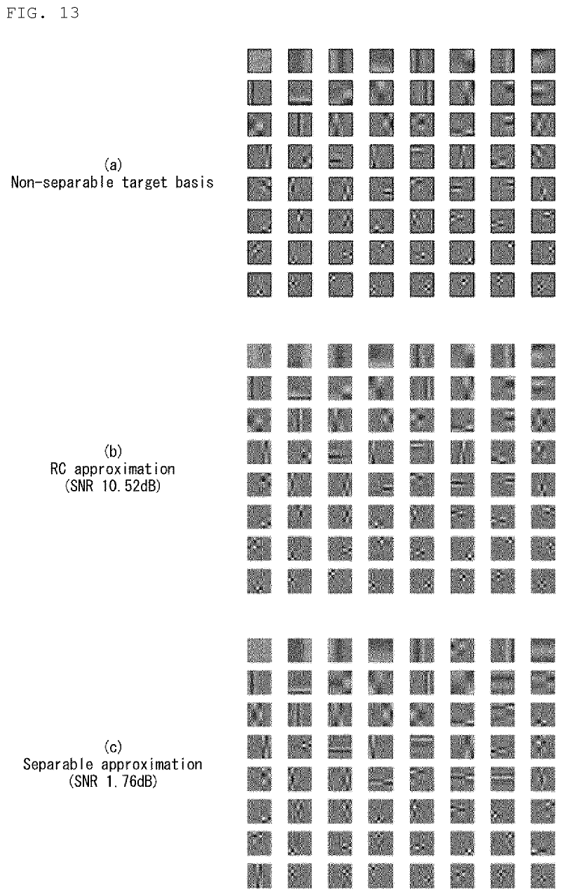

FIG. 9 shows approximation results of eight SOTs which uses RCTs and separable approximations. It is obvious that the RCTs outdo the separable transforms in any case. When the target SOT's direction approaches to vertical and horizontal directions the performance difference between RC and separable increases. This is illustrated in FIG. 13 which shows the resulting basis functions after the reordering permutation of the above Table 1, step 14. While RCT closely approximates SOT5 (primarily vertical), the separable approximation is poor especially on basis functions of smaller support.

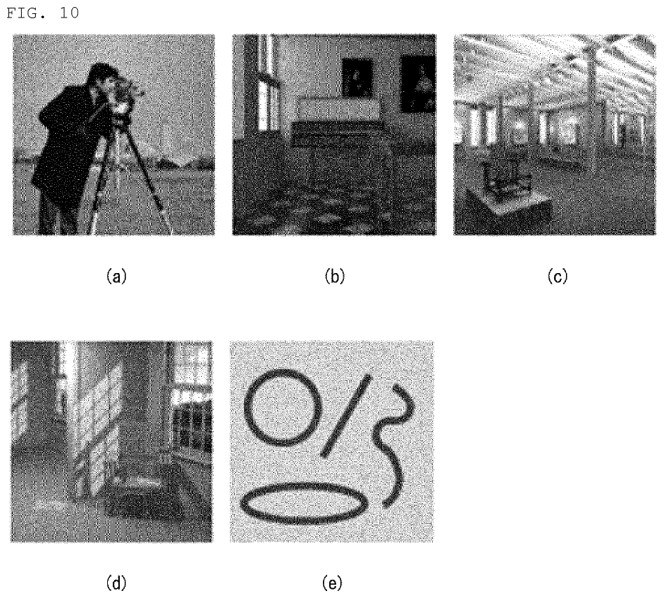

FIGS. 10 to 12 are diagrams illustrating a distortion rate and a gain rate for images according to embodiments of the present invention.

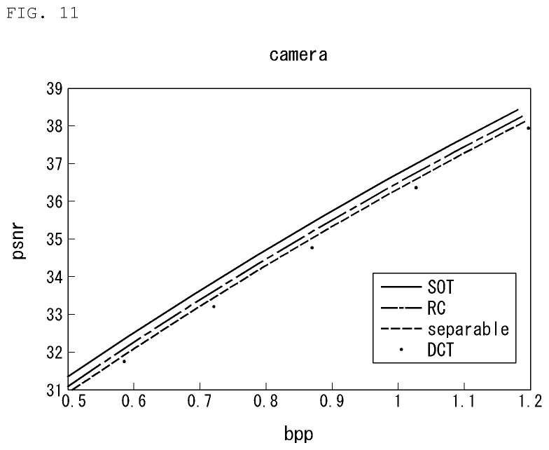

FIGS. 10(a) to (e) show five test images (Camera, Vermeer, Museum, Chair, and Graphics), and FIG. 11 shows a rate distortion of a camera original image from among the five test images.

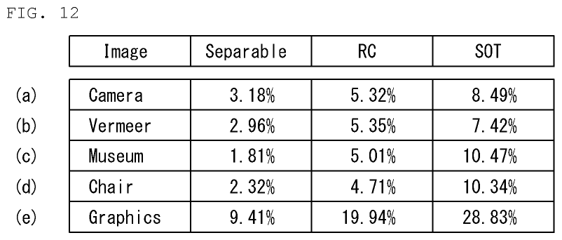

Using the images shown in FIG. 10, compression tests using Set Partitioning In Hierarchical Trees (SPIHT)-similar codecs are also performed. Each 8×8 block in an image may be classified as one of nine transforms (SOT1-SOT8 and DCT for SOT-based results, RCT1-RCT8 and DCT for RCT-based results, and separable 1-separable 8 and DCT for separable results). Classification information may be encoded as additional information. A DCT is indiscriminately used for all blocks, or FIG. 11 illustrates typical rate-distortion curves for a DCT-base codec which uses only the DCT, and FIG. 12 illustrate all rate-gains acquired by each codec.

As illustrated in FIG. 12, a RCT-base codec exhibits D-R performance close to that of a SOT-based codec, and outdoes a separable transform-based codec. For images (Camera, Vermeer, Graphics) similar to horizontal/vertical edges, a RCT is performed most similarly to an SOT. Images (Museum, Chair) similar to diagonal/anti-diagonal structures are more general, and RCT performance is somewhat more different from SOT performance.

FIG. 13 illustrates separable approximations to RC and (90°-oriented) SOT5 in the case of high RC approximation performance according to one embodiment of the present invention.

In FIG. 13, two simplications (RC and separable simplications) are rearranged so as to be matched with a target basis arrangement. While the separable simplication acquire a reduce quality approximation, the RC preserves high fidelity for a primitive basis.

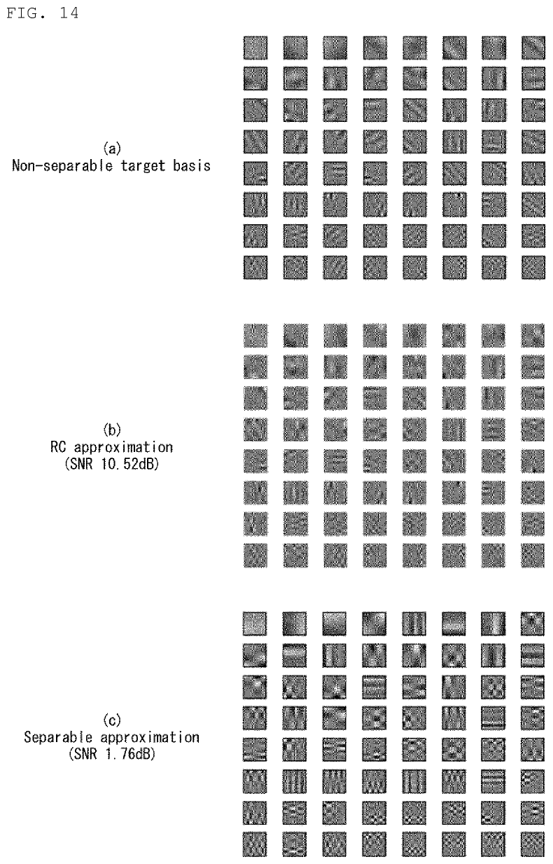

FIG. 14 illustrates separable approximations to RC and (135°-oriented) SOT7 in the case of low RC approximation performance according to one embodiment of the present invention.

FIG. 14 illustrates the case of the low RC approximation performance. That is, separable approximations to RC and (135°-oriented) SOT7. Two simplications (RC and separable simplications) are rearranged so as to be matched with a target basis arrangement. In this case, the RC and separable simplications acquire reduced quality approximations. The RC simplification still exhibits considerably better approximations compared to the separable simplification.

FIG. 14 illustrates approximation to SOT7 (primarily 135°), and, in this case, a RCT is not less precise compared to the case of FIG. 13. A separable approximation is even worse.

The present invention proposes RCTs which are two-dimensional non-separable transforms defined based on a set of one-dimensional linear transforms and a basis arrangement permutation.

RCTs have the same complexity as that of separable transforms in terms of an amount of computation, but it is able to approximate a given complex target transform with much increased fidelity. An algorithm to which the present invention is applied may optimize linear transforms related to a RCT as well as arrangement permutation.

According to the algorithm, it is found that the RCTs more precisely follow performance of complex transforms to be approximated, compared to separable approximations. As integrating rearrangement permutation, separable designs done by the proposed algorithm may be more excellent than pure separable approximations.

Therefore, it is found that RCTs of the present invention actually outdo well-designed separable approximations. All basis functions of a transform do not have the same significance in compression and other applications. In particular, when it is relatively hard to approximate transforms, it is possible to further improve application performance of the RCTs using weight functions.

As described above, the embodiments explained in the present invention may be implemented and performed in a processor, a micro-processor, a controller or a chip. For example, the functional modules explained in FIGS. 1, 2 and 4 may be implemented and performed on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus, and may be used to code video signals and data signals.

Furthermore, the decoding/encoding method to which the present invention is applied may be produced in the form of a program to be executed by a computer, and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a blue ray disk (BD), a USB, ROM, RAM, CD-ROM, a magnetic tape, a floppy disk, and an optical data storage device, for example. Furthermore, the computer-readable recording median includes media implemented in the form of carrier waves (e.g., transmission through the Internet). Furthermore, a bit stream generated by the encoding method may be stored in a computer-readable recording medium or may be transmitted over a wired/wireless communication network.

### INDUSTRIAL APPLICABILITY

The exemplary embodiments of the present invention have been disclosed for illustrative purposes, and those skilled in the art may improve, change, replace or add various other embodiments within the technical spirit and scope of the present invention disclosed in the attached claims.

1. A method for performing a transform using a Row-Column Transform (RCT), the method comprising:
deriving a row transform set, a column transform set and a permutation matrix based on a given transform matrix (H) and an error tolerance parameter;
obtaining a RCT coefficient based on the row transform set, the column transform set, and the permutation matrix; and
performing a quantization and an entropy-encoding on the RCT coefficient,
wherein the permutation matrix is obtained by permuting a row of an identify matrix.

2. The method of claim 1,
wherein the permutation matrix is derived from an optimization process, and the optimization process is determined based on a matching between a RCT matrix and the given transform matrix,
wherein the RCT matrix is derived using the row transform set and the column transform set.

3. The method of claim 1, wherein each transform in the row transform set and the column transform set is orthonormal.

4. The method of claim 1, wherein each of the row transform set and the column transform set has a single transform.

5. The method of claim 1, wherein the row transform set has a single transform, the column transform set has another single transform.

6. The method of claim 1, wherein the row transform set and the column transform are used for at least one of a square region, a rectangular region, or an arbitrary region.

7. The method of claim 1, wherein the RCT coefficient is obtained by performing a row transform and then a column transform.

8. A method of performing an inverse-transform using a Row-Column Transform (RCT), the method comprising:
receiving a video signal;
obtaining a coefficient from the video signal through entropy decoding and inverse-quantization;
performing an inverse-permutation on the coefficient;
performing an inverse-transform on the inverse-permutated coefficient; and
reconstructing the video signal using the inverse-permutated coefficient.

9. The method of claim 8, wherein the performing of an inverse-transform comprises:
performing an inverse-column transform on the inverse-permutated coefficient; and
performing an inverse-row transform on the row-column transformed coefficient.

10. The method of claim 8, wherein each transform in the row transform set and the column transform set is orthonormal.

11. The method of claim 8, wherein each of the row transform set and the column transform set has a single transform.

12. The method of claim 8, wherein the row transform set has a single transform, and the column transform set has another single transform.

13. The method of claim 8, wherein the row transform set and the column set are used for at least one of a square region, a rectangular region, or an arbitrary region.

14. An apparatus for performing a transform using a Row-Column Transform (RCT), the apparatus comprising:
a transform unit configured to derive a row transform set, a column transform set, and a permutation matrix based on a given transform matrix H and an error tolerance parameter, and obtain a RCT coefficient based on the row transform set, the column transform set, and the permutation matrix;
a quantization unit configured to perform a quantization on the RCT coefficient; and
an entropy encoding unit configured to perform an entropy encoding on the quantized RCT coefficient,
wherein the permutation matrix represents a matrix obtained by permutating a row of an identity matrix.

15. An apparatus for performing an inverse-transform using a Row-Column Transform (RCT), the apparatus comprising:
a receiver configured to receive a video signal including a residual signal;
an entropy decoding unit configured to entropy-decode the residual signal;
a de-quantization unit configured to de-quantize the entropy-decoded residual signal to obtain a coefficient;
an inverse-transform unit configured to perform an inverse-permutation on the coefficient and perform an inverse-transform on the inverse-permutated coefficient; and
a reconstruction unit configured to reconstruct the video signal using the inverse-transformed coefficient.
